(19) United States
(12) Patent Application Publication
(10) Pub. No.: US 2017/0262144 A1
(43) Pub. Date: Sep. 14, 2017

(54) MULTIPLE PRODUCT ATTRIBUTE VISUALIZATION

(71) Applicant: Wal-Mart Stores, Inc., Bentonville, AR (US)

(72) Inventors: Neeta N. Shah, Bentonville, AR (US); Anthony G. Wind, III, Gravette, AR (US)

(21) Appl. No.: 15/456,671

(22) Filed: Mar. 13, 2017

Related U.S. Application Data
(60) Provisional application No. 62/307,682, filed on Mar. 14, 2016.

(51) Int. Cl. G06F 3/0482; G06F 3/0485; G06Q 30/06

(52) U.S. Cl. CPC G06F 3/0482; G06Q 30/0623; G06F 3/0485

(57) ABSTRACT

A graphical user interface for the visualization of multiple product attributes is disclosed. Disclosed is a method for multiple product attribute visualization. Provided is the visual representation of relative attribute values of similar products along with a customer selected product. The customer may select the various attributes of the products to be displayed. The customer may also filter to remove products having certain relative attribute values.

### CROSS REFERENCE TO RELATED APPLICATION

This invention claims priority to United States provisional patent application serial number 62/307,682, filed Mar 14, 2016 to Applicant Wal-Mart Stores Inc., and entitled “Multiple Product Attribute Visualization.”

### BACKGROUND OF THE INVENTION

Technical Field

This invention relates to a graphical user interface for multiple product attribute visualization.

State of the Art

Background and statement of the problem.

Customers are often unable to find extensive details about products which they choose to purchase from both in store and online and are ultimately interested in buying. Customers also find difficulties in comparing and/or searching for similar products to the chosen product. They are interested in comparisons of products in order to make an informed decision when purchasing the selected product.

Accordingly, what is needed is an improved display format of comparable products in order to make an informed decision on which product to purchase.

### DISCLOSURE OF THE INVENTION

The disclosed invention relates to a graphical user interface for multiple product attribute visualization.

Disclosed is a graphical user interface for a wireless mobile computing device of a customer having a touch sensitive display through which the user interacts with the interface for the visual representation of multiple product attributes comprising: a scrollable home screen for visually displaying to the customer; wherein the mobile computing device captures product code data of a selected product having at least one product attribute; wherein a central processor is in communication with the mobile computing device through the graphical user interface; a display showing a comparison of the at least one product attribute of the selected product with at least one product attribute of a comparison product; wherein an identifier is used to link the selected product with at least one relative attribute value of the selected product; and wherein a different identifier is used to link the at least one comparison product with at least one relative attribute value of the comparison product for the visual representation of the multiple product attributes.

In some embodiments, the graphical user interface further comprises a plurality of the comparison products. In some embodiments, the identifier is color. In some embodiments, the identifier is symbols, shading, fill, and/or gray scale. In some embodiments, the comparison is displayed as a bar graph. In some embodiments, the mobile computing device captures the customer selection of the at least one attribute of the comparison product. In some embodiments, the mobile computing device captures the customer exclusion of the at least one relative attribute value of the comparison product. In some embodiments, the mobile computing device captures the customer selection of the at least one relative attribute value of the comparison product.

In one aspect disclosed is a method for multiple product attribute visualization comprising: selecting a product in store or online on a mobile device and entering a product code; selecting at least one attribute associated with the product, wherein a central processor selects at least one product having a related product code and having the at least one attribute; and providing visual representation of relative attribute values of the selected product and the at least one product having a related product code. In some embodiments, the at least one attribute is selected from the group consisting of price, popularity, value, and/or rating. In some embodiments, the visual representation is in the form of color, wherein color links the selected product and the at least one product having a related product code with the at least one attribute. In some embodiments, the visual representation is graphical. In some embodiments, the product code may be keyed in or scanned. In some embodiments, the price is actual price of the selected product and the at least one product having a related product code. In some embodiments, the popularity is number of units sold of the selected product and the at least one product having a related product code. In some embodiments, the value is actual price per unit of measure of the selected product and the at least one product having a related product code. In some embodiments, the rating is consumer rating of the selected product and the at least one product having a related product code.

The foregoing and other features and advantages of the invention will be apparent to those of ordinary skill in the art from the following more particular description of the invention and the accompanying drawings.

### BRIEF DESCRIPTION OF THE DRAWINGS

FIG. 1 shows an illustration of a graphical user interface according to the invention

FIG. 2 shows an illustration of a graphical user interface according to the invention.

FIG. 3 shows a process flow diagram for multiple product attribute visualization according to the invention.

FIG. 4 shows a system diagram for multiple product attribute visualization according to the invention.

FIG. 5 shows a data flow diagram for multiple product attribute visualization according to the invention.

### DETAILED DESCRIPTION OF EMBODIMENTS OF THE INVENTION

As discussed above, embodiments of the present invention relate to multiple product relative attribute visualization.

The system provides visual representation of relative attribute values of similar products along with the selected product. The system further provides options to select the various product attributes of the products to be displayed. The system still further includes filters to remove some products with certain relative attribute values.

The graphical user interface and the method for multiple product attribute visualization provide a consolidated view of relative attribute values for attributes of multiple products. The graphical user interface allows the customer to select the attributes to compare across the available products. With multiple product attribute visualization, the customer is equipped with the necessary tools to make an informed decision about the product to be purchased, resulting in fewer returns and/or exchanges.

The graphical user interface as described herein provides a consolidated view of relative attribute values of attributes of multiple products. Examples of product attributes include, but are not limited to price, value, rating and popularity. Price may be the actual price of a product. Value may represent the price per unit of measure. Rating may be the consumer rating of a product. Popularity may be the number of units sold.

The customer may select a product from the retail store (using a mobile computing device or kiosk) or make an online selection. The product code is then entered thru any media, i.e. scanning a barcode or keying in product data. The graphical user interface then displays visual representation of relative attribute values of product attributes of similar products. The relative attribute values are distributed across a range from minimum to maximum value, wherein the minimum and maximum values are defined by the data set being displayed.

The central processor may provide a default filter attributes selection the first time a customer/user logs in/uses the graphical user interface. Then after selecting those attributes, the attributes will be persisted along with customer detail information. For example, the default filters may have attributes such as price, value, or popularity.

Some of the filters may include ranges to be applied to the filters, such as price minimum and maximum, size or weight. Filters may also exclude certain properties of products, such as peanut or wheat products. Additionally, the customer may restrict the search to some maximum specified number of similar products using a filter.

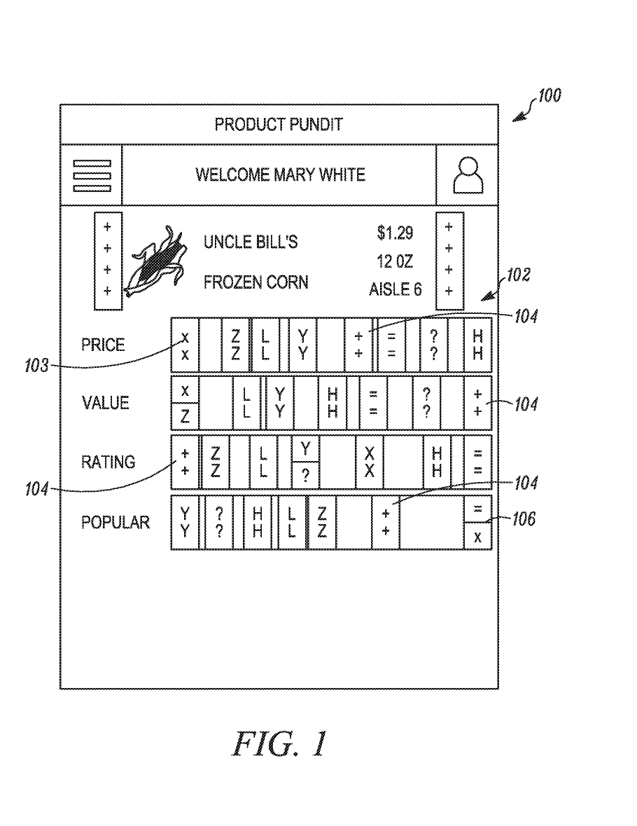

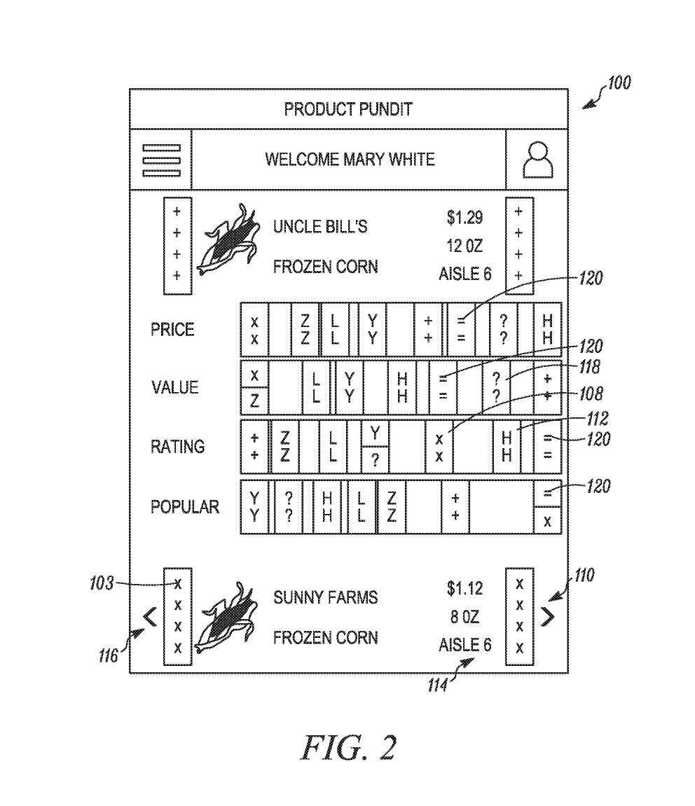

In FIGS. 1-2, symbols 102 are used to link the selected product and the comparable (similar) product(s) with the relative attribute values in the selected product area 102 and attribute comparison area 104. The customer (user) scans/keys in a selected product. The graphical user interface 100 shows comparable product(s) based on filters/preferences. In the graphical user interface illustration 100, the symbol ‘+’ 103 indicates the relative attribute value associated with the selected product and in each comparison area, the symbol ‘+’ 103 indicates the position among all product(s), selected and comparable. Two symbols indicates (for example for popularity attribute) two products having same relative attribute values in for that particular attribute, popularity 106. Customer may select a relative attribute value to see the comparable product associated with that relative attribute value 108. Symbols are again used to link the comparable product with relative attribute values in comparable product area 114.

The customer selects another attribute to see the comparable product associated with the relative attribute value 112 or uses next key 110 to see the next comparable product or back key 116 to see previously viewed comparable product. In this manner, customer may continue to select another attribute to see the comparable product associated with the relative attribute value 118 in the comparable product area 114. The comparable product associated symbol ‘=’ 120 may be the best buy. It is moderately priced, is a good value, has a superior rating and is a best seller. The customer may then select a different bar in the comparison area and the selected similar product is displayed. To see another similar product, customer may then select key 110 of FIG. 2 after customer selects another relative attribute value 108 in FIG. 2.

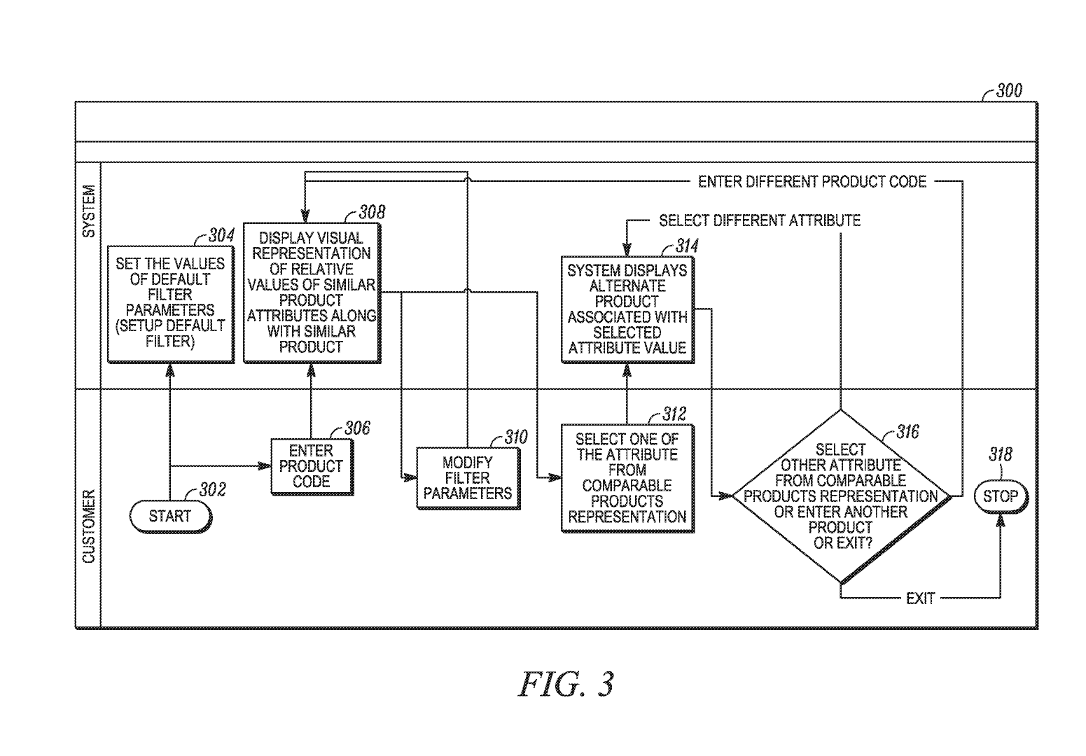

FIG. 3 illustrates a process flow diagram for multiple product attribute visualization 300. Customer starts 302. Central processor sets values of default filter parameters (setup default filter) 304. Customer enters product data 306 (by scanning or keying) of a selected product through a graphical user interface on a mobile computing device 306. Graphical user interface displays visual representation of relative attribute values of similar products 308. Customer may modify filter parameters 310 or customer may select one of the relative attribute values from similar (comparable) products representation 312. Graphical user interface displays alternate product associated with selected relative attribute value 314. Customer may select another relative attribute value from similar (comparable) products or enter another product or exit 316 and stop 318.

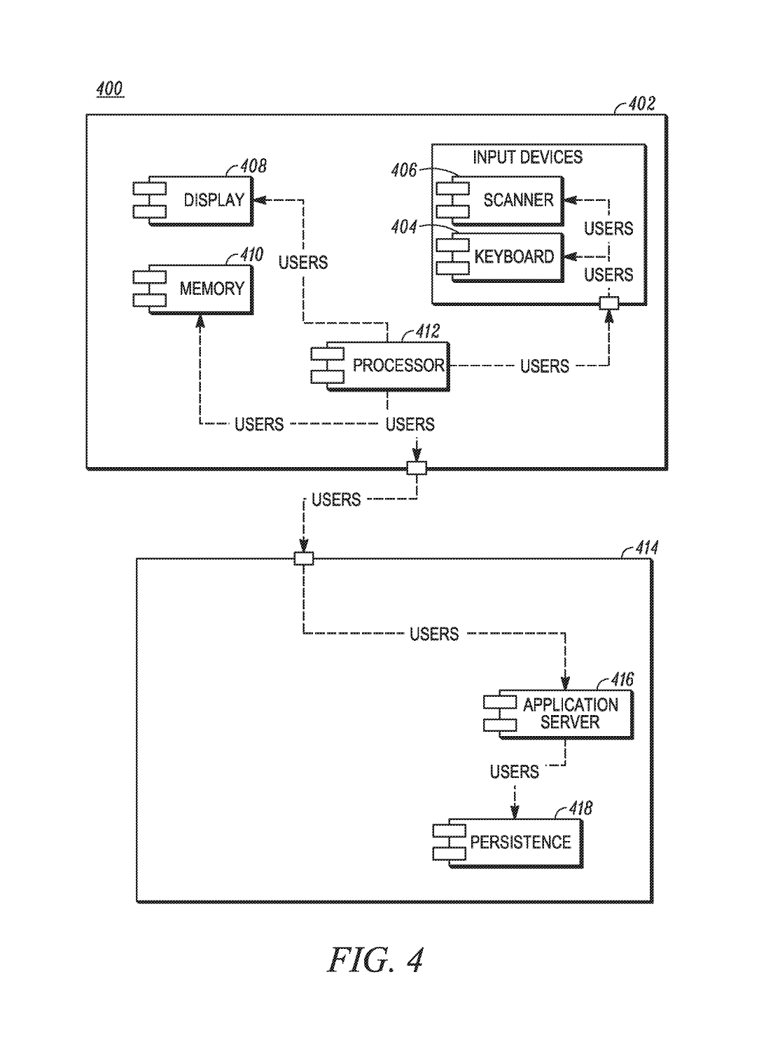

FIG. 4 illustrates a system diagram for multiple product attribute visualization 400. Customer mobile computing device 402 includes input devices keyboard 404 and scanner 406, display 408, memory 410 and processor 412 which is connected to central processor 414 including application server module 416 and persistence module 418.

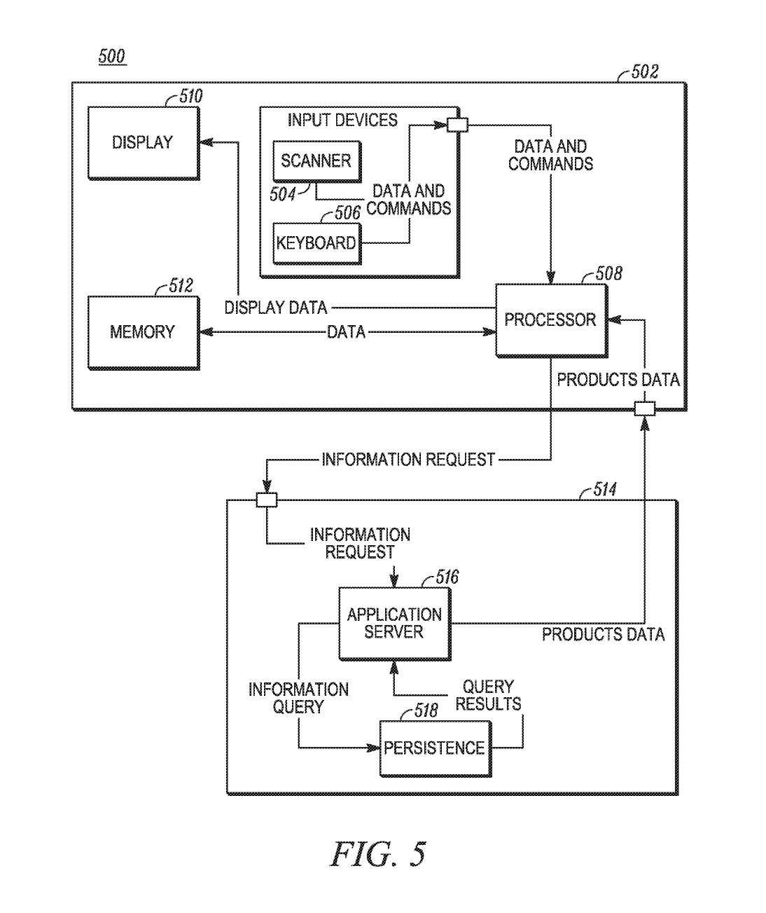

FIG. 5 illustrates a data flow diagram for multiple product attribute visualization 500. Data and commands flow in mobile computing device 502 from input devices scanner 504 and keyboard 506 to processor 508. Display data flows to display 510 from processor 508. Data flows to and from memory 512 from processor 508. Processor 508 sends product information request to application server module 516 of central processor 514 and receives product data from application server module 516. Application server module 516 sends product query request to persistence module 518 and receives query results from persistence module 518. Persistence module 518 stores product attributes.

As will be appreciated by one skilled in the art, aspects of multiple product attribute visualization may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

While the invention has been shown and described with reference to specific preferred embodiments, it should be understood by those skilled in the art that various changes in form and detail may be made therein without departing from the spirit and scope of the invention as defined by the following claims.

The foregoing and other features and advantages of the invention will be apparent to those of ordinary skill in the art from the following more particular description of the invention and the accompanying drawings.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

What is claimed is:

1. A graphical user interface for a wireless mobile computing device of a customer having a touch sensitive display through which the user interacts with the interface for the visual representation of multiple product attributes comprising:
a scrollable home screen for visually displaying to the customer;
wherein the mobile computing device captures product code data of a selected product having at least one product attribute;
wherein a central processor is in communication with the mobile computing device through the graphical user interface;
a display showing a comparison of the at least one product attribute of the selected product with at least one product attribute of a comparison product;
wherein an identifier is used to link the selected product with at least one relative attribute value of the selected product; and
wherein a different identifier is used to link the at least one comparison product with at least one relative attribute value of the comparison product for the visual representation of the multiple product attributes.

2. The graphical user interface of claim 1, further comprising a plurality of the comparison products.

3. The graphical user interface of claim 1, wherein the identifier is color.

4. The graphical user interface of claim 1, wherein the identifier is symbols.

5. The graphical user interface of claim 1, wherein the identifier is shading, fill, and/or gray scale.

6. The graphical user interface of claim 1, wherein the comparison is displayed as a bar graph.

7. The graphical user interface of claim 1, wherein the mobile computing device captures the customer selection of the at least one attribute of the comparison product.

8. The graphical user interface of claim 1, wherein the mobile computing device captures the customer selection of the at least one relative attribute value of the comparison product.

9. The graphical user interface of claim 1, wherein the mobile computing device captures the customer exclusion of the at least one relative attribute value of the comparison product.

10. The graphical user interface of claim 1, wherein the at least one relative attribute value of the selected product and the at least one relative attribute value of the comparison product are distributed across a range from minimum relative attribute value to maximum relative attribute value for each of the at least one product attributes.
